(19) United States
(12) Patent Application Publication
(10) Pub. No.: US 2006/0083942 A1
(43) Pub. Date: Apr. 20, 2006

(54) Conversion layer for bases made of zinc or zinc alloys

(75) Inventors: Christoph Schulz, Iserlohn (DE); Ralf Feser, Iserlohn (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hubert OTTE, Mainz (DE)

(21) Appl. No.: 10/515,618

(22) PCT Filed: May 19, 2003
(86) PCT No.: PCT/DE03/01617

§ 371 Date: Sep. 16, 2005

(30) Foreign Application Priority Data
May 22, 2002 (DE) 102 23 022.6

(51) Int. Cl. B32B 15/00

(52) U.S. Cl. 428/649

(57) ABSTRACT

The aim of the invention is to create a novel conversion layer, the properties of which regarding breakability, decorative effect, and mechanical abrasion are at least not worse than those of previously known conversion layers. Said aim is achieved by providing the inventive conversion layer with at least one doped siliceous layer that is obtained by applying at least one alkaline siliceous solution which additionally contains aluminum ions and/or ions of at least one B-group element and/or ions of at least one lanthanide and/or ions thereof, which have been complexed with at least one complexing agent, and/or at least one organic polar compound. The novel conversion layer can be used as a corrosion-proof and abrasion-proof protective coating for technical parts and/or for decorative purposes.

Conversion layer for bases made of zinc or zinc alloys The present invention relates to a conversion layer for bases made of zinc or zinc alloys as well as to the preparation and the use thereof.

Under the influence of humidity, zinc-containing and zinc coated metallic surfaces tend to the formation of corrosive white rust which is not desired. Known methods for the prevention or reduction are the application of conversion layer containing Cr or Cr(VI) in an acidic medium, the reduction of Cr(VI) with alkali sulfite in an alkaline alkali silicate solution (MacDermid JS500 and JS2000 method) and the sealing with alkaline coatings with or without admixtures of organic polymers. Furthermore, in EP 0 749 501 is disclosed a process employing a combination of dissolved inorganic silicate, a dissolved inorganic aluminate and a silyl-containing crosslinking agent.

Although Cr(VI) provides better protection than Cr(III) the use of Cr(VI) is of particular disadvantage due to its classification into cancer class I. Under the EU car recycling directive valid from Jul. 1, 2003 the amount of Cr (VI) per private car is furthermore limited to 2 grams. Due to these disadvantages, some automobile producers intend to completely refrain from Cr(VI). Although Cr(III) has been classified into cancer class 2 it is accepted by the industry as a replacement of Cr(VI). Cr(III), however, has the disadvantage that deposition from acidic media as known under the designation Chromitierung® (DE 196 15 664 A1) does not result in the same anticorrosive properties as obtained in the case of Cr(VI). Furthermore, waste waters contaminated by Cr(III) and Cr(VI), respectively, produced in the preparation of the conversion layers, generally pose an important problem.

The known silicatic coatings have the advantage of easy accessibility, low costs of their raw materials and of good adherence to metallic bases. Disadvantageous, however, with respect to the known silicatic coatings is their moisture vapor transmission so that bases which do not incorporate coat additives (e.g.: zinc dust, Mo-containing pigments) are quickly corroded. Furthermore, another disadvantage is the relatively high proportion of silicate which results in brittleness with the layer thicknesses used. To at least reduce the brittleness in the known silicatic coatings, organic and also water-suspendable polymers are admixed to the coating solution, or alkoxysilane compounds are used such as described in DE 100 14 035. A further disadvantage of the known silicatic layers is that a blue discoloration of the surface can occur, such as e.g. in the case of a “blue passivation”.

The process described in EP 0 749 501 has a disadvantage due to the high toxicity of the silyl-containing crosslinking agents and the necessity of baking.

Conversion layers are not only used for anticorrosive purposes but also as a decorative coat as described in DE 100 14 035. Furthermore, also the natural post-patination of zinc is widely used as a decorative effect while the known conversion layers can adversely affect the natural post-patination or can prevent its visualization.

It is an object of the present invention to provide a conversion layer for bases made of zinc or zinc alloys wherein the conversion layer is intended to have at least equal properties to those of known conversion layers with respect to anticorrosive effect, brittleness, decorative effect, and mechanical abrasion.

According to the invention, this object has been achieved by the fact that the conversion layer consists of at least one doped silicatic layer which can be obtained by application of at least one silicatic solution which additionally contains ions and/or ions complexed with at least one complexing agent of at least one transition element and/or at least one lanthanide and/or of aluminium and/or at least one organic polar compound.

Further features may be seen from the dependent claims.

The preparation of the conversion layer may be performed by application of the silicatic layer by known methods (e.g. by the dipping method, rolling, blade coating, spraying, atomising, etc.).

Useful as the silicatic solutions are e.g. alkali water glasses and/or amino water glasses and/or organosiloxane-containing solutions wherein water serves as a solvent. Since the concentration to be used is dependent on the base to be coated and the additives used in solution, the concentration and the type of water glass must be determined empirically by those skilled in the art depending on the desired requirements without an inventive step in the scope of the claimed teaching from the state of the art. In a non-limiting manner and cited as a starting point for the empirical determination the solution generally contains 1 to 10% by wt. of the alkali/amino water glass.

Suitable as additives in the silicatic solution are ions and/or ions complexed by a complexing agent of the transition elements (e.g. Fe, Cr, Mo, Ag, W, V, Ti, Y, Zr, Hf, etc. and the lanthanides (e.g. La, Ce, Nd, Gd, Yb, etc.). Further suitable are ions and/or ions complexed with at least one complexing agent of aluminium as an additive to the silicatic solution. Since the concentration to be used and the form of the additive is dependent on the base to be coated, the silicatic solution, the other solution additives used, etc., and since it may also be restricted by legislative regulations, the concentration and the form of each individual additive must also be determined empirically by those skilled in the art according to the requirements desired without an inventive step in the scope of the claimed teaching from the state of the art.

Given in a non-limiting manner and as a starting point for the empirical determination the ready-to-use solution contains about 0.01% by wt. of each additive. Introduction into the silicatic solution can be performed by means of the known methods, e.g. by stirring in (for example as an aqueous hydroxide suspension, as a form of a phosphate, in a complexed form, etc.) into a water glass solution, as a melt additive (e.g. in the form of a carbonate, etc.) of the water glass, etc.) during the preparation of the water glass solution.

Suitable as an addition to the silicatic solution are organic polar compounds and/or complexing agents (e.g. a mono-, di-, polycarboxylic acid, an organic amine, an organic phosphate, an organic phosphonate, an organic sulfonate, a hydrazone, a mercaptane, a stearate, etc.). These additives serve e.g. as a wetting agent, a solubility modifier, inhibitor, etc., and can be introduced into the silicatic solution by means of the known methods (e.g. by direct stirring in, addition in the form of a complex compound with other additives, in the preparation of the water glass as a melt additive to the water glass, etc.). It should be explicitly pointed out that an organic polar compound can have several properties (e.g. wetting agent and complexing agent) and that the complexing agent can also be an inorganic compound. As for the other additives, the concentration and form to be used must also be determined by those skilled in the art in each individual case depending on the requirements desired without an inventive step in the scope of the claimed teaching from the state of the art. In a non-limiting manner and given as a starting point for the empirical determination the ready-to-use solution generally contains about 0.01% by wt. of additives of organic compound/chelating agent.

In the scope of the claimed teaching, the invention may furthermore be embodied in a way that two or more additives of the silicatic solution can be added with each other. In a non-limiting manner, mention is made of the addition of Ag and one of the other transition elements such as Ce. It should be explicitly pointed out that in this respect the individual properties of the additives may not be additive and can affect each other, the determination of which, however, lies within the skills of those skilled in the art without an inventive step in the scope of the claimed teaching from the state of the art.

The advantages obtained by means of the invention particularly are that
the conversion layers prepared may be very thin so that no flaking will be recognized upon bending of a sheet metal coated therewith,
the conversion layers prepared show no surface discoloration, such as e.g. a “blue passivation”,
by means of the respective additives the anticorrosive effect is very close or even superior to the passivating effect of Cr (VI),—the decorative effect of e.g. natural post-patination is maintained,
no waste waters to be disposed are obtained because e.g. rewashing can be omitted. The conversion layer of the invention can be used as an anticorrosive and antiabrasive protective coating for technical parts and/or for decorative purposes and thus is of a high commercial importance.

In the following, the claimed teaching will be explained in more detail with respect to several Examples in a non-limiting manner. The concentrations mentioned in the Examples were optimised empirically using the corrosion test according to DIN 50017 (40° C., 100% humidity) and by means of statistical methods.

### EXAMPLE 1

Use of Cr(III):

0.1% (by weight based on Cr (III)) of Cr(III)hydroxide obtained from Cr(III)nitrate was stirred into water glass solution having a solids content of 36% by wt., wherein it was dissolved. The concentrate thus obtained was diluted 1+9 with water and applied to a zinc surface.

In the corrosion test according to DIN 50017 the coated parts showed a proportion of white rust of 0% after 12 days. On iron screws having a galvanic Zn, ZnFe, ZnNi coating, the salt spray test according to DIN 50021 demonstrated a serviceable life until the first occurrence of white rust of up to 600 h for ZnNi, and up to 260 h for Zn and ZnFe.

### EXAMPLE 2

Use of Zr Carbonate:

200 mg of Zr carbonate were dissolved in 2 ml HNO₃, precipitated with KOH ad pH 11, washed twice with H₂O and in each case centrifuged, and 4 ml H₂O were added. 15 ml of potash water glass with a solids content of 36% by wt. were added. The concentrate thus obtained was diluted 1+4,4 with water and applied to a zinc surface.

In the corrosion test according to DIN 50017 the coated parts showed a proportion of white rust of 0% after 12 days.

### EXAMPLE 3

Use of Ce(III):

From 50 mg of Ce₂ (SO₄)₃ Ce(OH)₃ was precipitated by KOH ad pH 8, washed twice with H₂O and in each case centrifuged, and 4 ml H₂O were added. 15 ml of potash water glass with a solids content of 36% by wt. were added. The concentrate thus obtained was diluted 1+4,4 with water and applied to a zinc surface.

In the corrosion test according to DIN 50017 the coated parts showed a proportion of white rust of 0% after 12 days.

### EXAMPLE 4

Use of Ce(IV):

From 50 mg of Ce (SO₄)₂ Ce (OH)₄ was precipitated with KOH ad pH 8, washed twice with H₂O and in each case centrifuged, and 4 ml H₂O were added. 15 ml of potash water glass with a solids content of 36% by wt. were added. The concentrate thus obtained was diluted 1+4,4 with water and applied to a zinc surface.

In the corrosion test according to DIN 50017 the coated parts showed a proportion of white rust of 0% after 12 days.

### EXAMPLE 5

Use of Phthalic Acid:

200 mg of phthalic acid were mixed successively with 1 ml NH₃ (25%) and 4 ml H₂O and 15 ml water glass having a solids content of 36% by wt. The concentrate thus obtained was diluted 1+4,4 with water and applied to a zinc surface.

In the corrosion test according to DIN 50017 coated parts showed a proportion of white rust of <2% after 12 days.

### EXAMPLE 6

Use of Adipic Acid:

200 mg of adipic acid were mixed successively with 1 ml NH₃ (25%) and 4 ml H₂O and 15 ml water glass having a solids content of 36% by wt. The concentrate thus obtained was diluted 1+4,4 with water and applied to a zinc surface.

In the corrosion test according to DIN 50017 coated parts showed a proportion of white rust of <2% after 12 days.

### EXAMPLE 7

Use of Fe(III):

Hematite was stirred into water glass having a solids content of 36% by wt. until the solution assumed a brownish color. The concentrate thus obtained was decanted and diluted 1+9 with water and applied to a zinc surface.

In the corrosion test according to DIN 50017 coated parts showed a proportion of white rust of <4% after 12 days.

### EXAMPLE 8

Use of EDTA as Complexing Agent:

200 mg of EDTA were brought to pH 10.5 with NH₃ (25%) and filled up to 20 ml with water glass having a solids content of 36% by wt. The concentrate thus obtained was diluted 1+9 with water and applied to a zinc surface.

In the corrosion test according to DIN 50017 coated parts showed a proportion of white rust of <2% after 12 days.

### EXAMPLE 9

Use of Urotropine:

400 mg of urotropine were dissolved in 100 ml H₂O, 30 ml of water glass having a solids content of 36% by wt. were added and H₂O was added ad 200 ml. The solution thus obtained was directly applied to a zinc surface.

In the corrosion test according to DIN 50017 coated parts showed a proportion of white rust of <2% after 12 days.

### EXAMPLE 10

Use of Ce(IV)+Ag:

50 mg of Ce(SO₄)₂ were precipitated with KOH ad pH 8, washed twice with H₂O and in each case centrifuged, and 4 ml H₂O were added. 15 ml of potash water glass with a solids content of 36% by wt. were added. To this 1 ppm Ag was added (as Ag(OH)₂). The concentrate thus obtained was diluted 1+4,4 with water and applied to a zinc surface.

In the corrosion test according to DIN 50017 coated parts showed a proportion of white rust of 0% after 12 days.

1-7. (canceled)

8. A method of protecting a surface of a zinc-containing metallic substrate from corrosion or abrasion, said method comprising coating said surface with a doped silicatic conversion layer by applying to said surface a silicatic solution comprising a silicate and at least one member selected from the group consisting of (i) an ion of a member selected from the group consisting of transition elements, lanthanides, and aluminum, (ii) a polar organic compound, and (iii) any of said ions complexed with a complexing agent.

9. The method of claim 8 wherein said silicate is a member selected from the group consisting of alkali water glasses and ammonium water glass.

10. The method of claim 8 wherein said ion is an ion of a transition element selected from the group consisting of Fe, Co, Ni, Cr, Mo, Cu, Ag, W, V, Ti, Y, Zr, and Hf.

11. The method of claim 8 wherein said ion is a lanthanide ion selected from the group consisting of La, Ce, Nd, Gd, and Yb.

12. The method of claim 8 wherein said ion is an aluminum ion.

13. The method of claim 8 wherein said polar organic compound is selected from the group consisting of monocarboxylic acids, dicarboxylic acids, polycarboxylic acids, organic hydroxycarboxylic acids, organic polyhydroxycarboxylic acids, glycols, alcohols, organic amines, organic amino acids, organic polyamino acids, organic phosphates, organic phosphonates, organic sulfonates, hydrazones, mercaptans, and stearates.

14. A conversion layer coating a zinc-containing metallic substrate, said conversion layer formed by the method of claim 8.

15. A conversion layer coating a zinc-containing metallic substrate, said conversion layer formed by the method of claim 9.

16. A conversion layer coating a zinc-containing metallic substrate, said conversion layer formed by the method of claim 10.

17. A conversion layer coating a zinc-containing metallic substrate, said conversion layer formed by the method of claim 11.

18. A conversion layer coating a zinc-containing metallic substrate, said conversion layer formed by the method of claim 12.

19. A conversion layer coating a zinc-containing metallic substrate, said conversion layer formed by the method of claim 13.
